(19) United States
(12) Patent Application Publication
(10) Pub. No.: US 2018/0092332 A1
(43) Pub. Date: Apr. 5, 2018

(54) GROOMING TOOL FOR PETS

(71) Applicant: Nestec SA, Vevey (CH)

(72) Inventor: Mark Harris, Concord (AU)

(21) Appl. No.: 15/547,947

(22) PCT Filed: Feb. 5, 2016
(86) PCT No.: PCT/IB2016/050617

§ 371 Date: Aug. 1, 2017

(30) Foreign Application Priority Data
Feb. 20, 2015 (AU) 2015900595

(51) Int. Cl. A01K 13/00; B26B 21/12

(52) U.S. Cl. CPC A01K 13/002; B26B 21/12

(57) ABSTRACT

A pet grooming tool that includes a base portion 2, a plurality of teeth extending therefrom with at least two different respective tip lengths 3, 4; and a blade edge 5 extending between at least some of said plurality of teeth. The blade edge forms a U-shape between said at least some of said plurality of teeth.

### CROSS REFERENCE TO RELATED APPLICATIONS

This application claims priority to Australian Provisional Application No. 2015900595 filed Feb. 20, 2015, the disclosure of which is incorporated herein by this reference.

### FIELD OF THE INVENTION

The present invention relates to grooming tools and in particular to pet grooming tools.

The invention has been developed primarily for providing a grooming tool for use in grooming a furred pet and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Many furred pets, such as dogs and cats, tend to moult or shed hair, which can be problematic for pet owners to clean off various household surfaces. As such, pet owners generally want to remove the loose hair from their pets in a controlled manner, commonly utilising commercially available grooming tools such as brushes or combs. However, in grooming a furred animal, there typically exists a balance between the removal of loose hair (i.e. hair that has become loose or has completely detached from the animal) and leaving the intact hair in the animals coat. For example, with traditional brushes and combs, the non-loose hair is left intact on the animal's coat, but these tools have a limited ability to remove the loose undercoat hair from the fur. As such, the use of such tools in grooming pets is excessively time consuming and ineffective as these tools do not collect loose undercoat hair.

In an attempt to selectively remove the loose hair from furred pets, some pet groomers have found that the blade from an electric clipper can be removed from the machine and utilised as a handheld grooming tool. The clipper blade, used similarly to a comb, includes a plurality of teeth and a sharpened edge, which assists in the collection of loose undercoat hair. However, the clipper blade is not designed for free use and can be difficult to grip, resulting in user fatigue in the hands and wrists.

In an effort to overcome this handling problem, some attempts have included mounting the clipper blade onto a handle, as detailed in at least U.S. Pat. No. 6,782,846.

While the use of the electric clipper blade was found to remove some of the loose undercoat hair, the sharpened edge, which forms a V-shaped forge in-between each pair of adjacent teeth, was found to pull or cut some of the intact, healthy hairs from the topcoat in use. This is caused by a reverse-scissor action between the V-shaped forge and the pet hair as the edge is drawn over the pet fur. This is problematic as the pulling or cutting of the hair causes the pet physical discomfort or pain, and the removal of the topcoat could expose the pet's undercoat or skin to external factors such as rain and/or UV radiation. This could have negative health implications in, for example, impacting upon the thermoregulation of the pet and/or burning of the pet's skin.

Furthermore, the cutting of the fur is also detrimental to the aesthetics of the pet, which can be extremely important for pets that compete in shows which judge the pet's physical appearance, e.g. conformation dog shows. Consequentially, for at least the reasons above, many professional pet groomers are wary of these grooming products and have opted not to use them.

### OBJECT OF THE INVENTION

It is an object of the present invention to overcome or ameliorate at least one of the disadvantages of the prior art, or to provide a useful alternative.

It is an object of the invention in its preferred form to provide a pet grooming product that can at least partially collect loose undercoat hair while causing minimal harm to the live topcoat hair.

### SUMMARY OF THE INVENTION

According to a first aspect of the invention, there is provided a head for a pet grooming tool including:
a base portion;
a plurality of teeth extending therefrom with at least two different respective tip lengths; and
a blade edge extending between at least some of said plurality of teeth;
   wherein said blade edge forms a U-shaped forge between said at least some of said plurality of teeth.

Preferably, the blade edge is adapted to differentiate between intact healthy hair and loose hair of a pet, and selectively collect the loose hair when said head is drawn over pet fur.

The blade edge is preferably adapted to reduce the shear stress on individual hairs when said head is drawn over pet fur.

The plurality of teeth preferably has ends that are:
(i) all substantially rounded; or
(ii) all substantially tapered; or
(iii) all substantially angular; or
(iv) any combination of substantially rounded, substantially tapered, and substantially angular.

The plurality of teeth preferably have tip lengths vary in accordance with a predetermined pattern. More preferably, the predetermined pattern is an alternation between a high tip length and a low tip length.

Preferably the blade edge forms a U-shaped forge between each adjacent tooth.

In one embodiment, the blade edge is preferably substantially dulled.

In another embodiment, the blade edge is preferably substantially sharpened.

According to a second aspect of the invention, there is provided a pet grooming tool including:
a head according to the first aspect; and
a handle, attached to said head, for gripping by a user

In one embodiment, the handle is preferably attached to said head such that said plurality of teeth and/or said blade edge is mounted with a leading angle of less than 90 degrees. More preferably, the angle is about 45 degrees.

In another embodiment, the handle is preferably attached to said head such that said plurality of teeth and/or said blade edge is mounted with a trailing angle of more than 90 degrees.

Preferably the handle is adapted to be grippable in a plurality of manners.

### BRIEF DESCRIPTION OF THE DRAWINGS

Preferred embodiments of the invention will now be described, by way of example only, with reference to the accompanying schematic drawings in which:

FIG. 1 is a close-up front view of a head for a pet grooming tool according to the invention;

FIG. 2 is a front perspective view of a pet grooming tool including the head of FIG. 1;

FIG. 3 is a side view of the pet grooming tool.

### PREFERRED EMBODIMENTS OF THE INVENTION

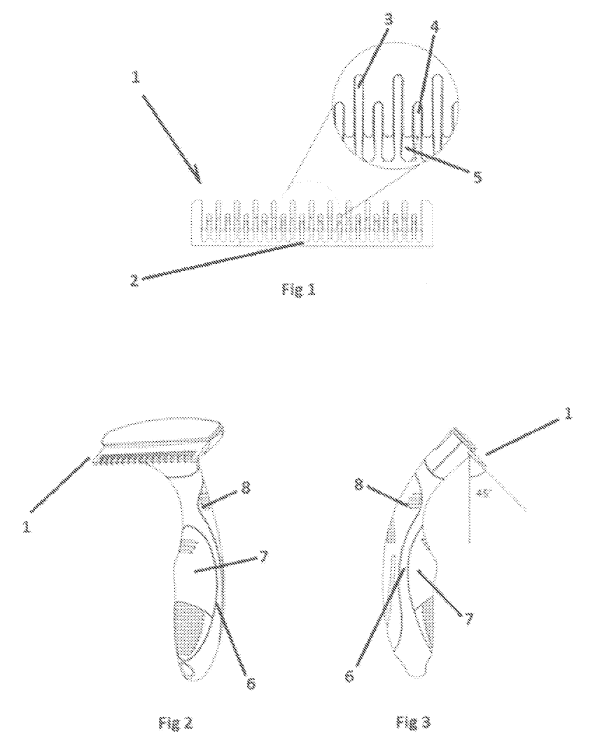

Referring initially to FIG. 1, the head 1 for a pet grooming tool includes a base 2 and a plurality of teeth extending therefrom, shown in the form of alternating teeth lengths with a high tip length 3 and a low tip length 4. The tips of the teeth have been shown to have slightly rounded ends; however in some embodiments the tips may be tapered and/or have a substantially angular end. In alternative embodiments, the tip lengths may be arranged in any combination such that there are at least two different tip lengths. This can include, but is not limited to, a set of two or more of tips with a first length followed by two or more tips with a second length, or wherein there are an uneven amount of tips with a first tip length and tips with a second tip length.

The head 1 also includes a blade edge 5 extending between at least some of the teeth, wherein the blade edge forms a U-shaped forge. In this embodiment, the blade edge 5 has been shown to form a U-shaped forge between each adjacent pair of teeth; however in other embodiments the blade edge may be provided as a U-shaped forge between only some of the teeth. In further embodiments, the blade edge may be substantially dulled to minimise the risk of cutting any live hair while allowing the discrimination of loose undercoat hair to live topcoat hair; however in some embodiments the blade may be substantially sharpened.

The blade edge forming a U-shaped forge has been purposely developed by the inventors to be able to differentiate between the intact healthy hair and the loose hair of a pet, and selectively collect the loose hair with minimal pulling, cutting or crimping of the intact healthy hair. While this edge functions similarly to the V-shaped forge of the prior art, the V-shaped forge does not differentiate the healthy and loose hair, and applies a shear force to each hair that is caught within the forge. This shear force causes the healthy hair to be pulled or cut through a reverse-scissor action as the edge is drawn along the fur of the pet. Conversely, the U-shaped forge has been specifically designed to significantly reduce shear stress inflicted from the reverse-scissor action as the edge is drawn along the fur of a pet, and instead the hairs are allowed to bend and pass underneath the forge such that they are not pulled nor cut. This is particularly advantageous as use of the U-shaped forge allows the removal of the loose undercoat while maintaining the healthy topcoat and thus minimising or overcoming the aesthetic and health issues that arise with the use of grooming tools with a V-shaped forge.

Referring to FIGS. 2 and 3, the head 1 is designed to be attached to a handle 6, shown with an anterior ergonomic grip 7 and a posterior ergonomic grip 8, to form the pet grooming tool. The handle has been shown to be substantially curved to assist ergonomic use; however alternative handles may also be used.

It was surprisingly found that the head 1 and the blade edge 5 had an increased effectiveness in collecting loose undercoat hair when mounted at a leading angle of about 45 degrees relative to the handle 6, as shown in FIGS. 2 and 3. While this angle appears to be optimal for grooming furred pets, alternative mounting angles have been considered, particularly about 30, 60 and 90 degrees relative to the handle. Furthermore, trailing angles of about 120, 135 and 150 degrees relative to the handle have also been considered in attempts to further reduce the shear stress inflicted upon the hair by the blade edge.

To use the pet grooming tool, the handle 6 is gripped by a users hand and presented perpendicular to the pet fur. Due to the design of the anterior grip 7 and the posterior grip 8, the handle may be gripped in a plurality of manners in accordance with the comfort of the user. With the embodiment shown in FIGS. 2 and 3, this results in the head 1 and the blade edge 5 being presented to the pet fur at an angle of 45 degrees. The user then draws the head along the pet fur in a downward motion toward the distal end of the handle, resulting in the high tip teeth 3, the low tip teeth 4 and the blade edge 5 removing any loose hair on the pet fur, including the loose undercoat hairs, while causing minimal harm to any live hairs. This action can be repeated to increase the amount of loose hair collected, until the pet is substantially free of loose hair.

It will be appreciated that the illustrated embodiment provides a pet grooming product that can at least partially collect loose undercoat hair while causing minimal harm to the live topcoat hair

Although the invention has been described with reference to a specific example, it will be appreciated by those skilled in the art that the invention may be embodied in many other forms.

1. A head for a pet grooming tool including:
a base portion;
a plurality of teeth extending from the base portion with at least two different respective tip lengths; and
a blade edge extending between at least some of said plurality of teeth;
wherein said blade edge forms a U-shaped forge between said at least some of said plurality of teeth.

2. The head according to claim 1 wherein said blade edge is adapted to differentiate between intact healthy hair and loose hair of a pet, and selectively collect the loose hair when said head is drawn over pet fur.

3. The head according to claim 1 wherein said blade edge is adapted to reduce shear stress on individual hairs when said head is drawn over pet fur.

4. The head according to claim 1 wherein said plurality of teeth have ends that are:
(i) all substantially rounded; or
(ii) all substantially tapered; or
(iii) all substantially angular; or
(iv) any combination of substantially rounded, substantially tapered, and substantially angular.

5. The head according to claim 1 wherein said plurality of teeth have tip lengths that vary in accordance with a predetermined pattern.

6. The head according to claim 5 wherein said predetermined pattern is an alternation between a high tip length and a low tip length.

7. The head according to claim 1 wherein said blade edge forms a U-shaped forge between each adjacent tooth of the plurality of teeth.

8. The head according to claim 1 wherein said blade edge is substantially dulled.

9. The head according to claim 1 wherein said blade edge is substantially sharpened.

10. A pet grooming tool including:
the head according to claim 1; and
a handle, attached to said head, for gripping by a user.

11. The pet grooming tool according to claim 10 wherein said handle is attached to said head such that said plurality of teeth and/or said blade edge is mounted with a leading angle of less than 90 degrees.

12. The pet grooming tool according to claim 11 wherein said angle is about 45 degrees.

13. The pet grooming tool according to claim 10 wherein said handle is attached to said head such that said plurality of teeth and/or said blade edge is mounted with a trailing angle of more than 90 degrees.

14. The pet grooming tool according to claim 10 wherein said handle is adapted to be grippable in a plurality of manners.
